(19) United States
(12) Patent Application Publication
(10) Pub. No.: US 2019/0383973 A1
(43) Pub. Date: Dec. 19, 2019

(54) OPTICAL STACK STRUCTURE INTEGRATED WITH POLARIZING LAYER AND TOUCH SENSOR AND IMAGE DISPLAY DEVICE INCLUDING THE SAME

(71) Applicant: DONGWOO FINE-CHEM CO., LTD., Jeollabuk-do (KR)

(72) Inventors: So Eun JANG, Gyeonggi-do (KR); Ko Eun KIM, Gyeonggi-do (KR); Dong Hwi KIM, Sejong-si (KR); Geo San LIM, Seoul (KR)

(21) Appl. No.: 16/547,864

(22) Filed: Aug. 22, 2019

Related U.S. Application Data
(63) Continuation of application No. PCT/KR2018/002223, filed on Feb. 23, 2018.

(30) Foreign Application Priority Data
Feb. 23, 2017 (KR) 10-2017-0024407

(51) Int. Cl. G02B 1/14; G02B 5/30; G02F 1/1333; G06F 3/041; G06F 1/16

(52) U.S. Cl. CPC G02B 1/14; G02B 5/3016; G02B 5/3041; G02B 5/3083; G06F 2203/04102; G06F 3/0412; G06F 1/1652; G06F 2203/04103; G02F 1/13338

(57) ABSTRACT

An optical stack structure includes a window, and a polarizing layer and a touch sensor layer on a surface of the window. The optical stack structure has improved flexibility and mechanical reliability so that the optical stack structure may be applied as a window substrate of an image display device including a flexible display.

### CROSS REFERENCE TO RELATED APPLICATIONS AND CLAIM OF PRIORITY

The present application is a continuation application to International Application No. PCT/KR2018/002223 with an International Filing Date of Feb. 23, 2018, which claims the benefit of Korean Patent Application No. 10-2017-0024407 filed on Feb. 23, 2017 at the Korean Intellectual Property Office, the disclosures of which are incorporated by reference herein in their entirety.

### BACKGROUND

### 1. Field

The present invention relates to an optical stack structure integrated with a polarizing layer and a touch sensor and an image display device including the same.

### 2. Description of the Related Art

Recently, a display device that may display information including an image is actively developed. The display device may include a liquid crystal display (LCD) device, an organic light emitting display (OLED) device, a plasma display panel (PDP) device, a field emission display (FED) device, etc.

A window substrate for protecting a display panel from an external environment may be disposed over the display panel such as an LCD panel or an OLED panel. The window substrate may be formed of glass. As a flexible display device is being developed, a transparent plastic material is also applied to the window substrate.

An additional member such as a polarizing plate, a touch screen panel, etc., may be further included between the window substrate and the display panel. For example, an external light reflected from an electrode pattern of the display panel may be blocked by the polarizing plate. A user's instruction may be input through a display screen by the touch screen panel.

However, as a plurality of layers or structures including the polarizing plate, the touch screen panel, the window substrate, etc., is stacked on the display panel, recent demands for the display devices such as an enhanced flexible property and a thin-layered structure may not be sufficiently realized. Further, as a plurality of the layers or the structures is stacked, a sufficient flexible property may not be achieved while maintaining mechanical strength and stability.

For example, Korean Published Patent Application No. 2012-0076026 discloses a transparent substrate including a polarizing plate and a touch screen panel.

### SUMMARY

According to an object of the present invention, there is provided an optical stack structure having improved mechanical reliability and flexible property.

According to an aspect of the present invention, there is provided an image display device which includes an optical stack structure having improved mechanical reliability and flexible property.

The above aspects of the present inventive concepts will be achieved by the following features:

(1) An optical stack structure, comprising a window; and a polarizing layer and a touch sensor layer on a surface of the window.

(2) The optical stack structure according to the above (1), wherein the window includes one surface and an opposite surface relative to the one surface, wherein the polarizing layer and the touch sensor layer are stacked on the one surface, and the opposite surface is toward a viewer side.

(3) The optical stack structure according to the above (1), wherein the optical stack structure satisfies Equation 1 below.

300 MPa %≤amended toughness [Equation 1]

In the Equation 1 above, the amended toughness is a multiplication of a stress (MPa) and a strain (%) at a fracture point in a stress-strain curve of the optical stack structure.

(4) The optical stack structure according to the above (3), wherein the amended toughness is 400 MPa % or more.

(5) The optical stack structure according to the above (3), wherein the amended toughness is 1,000 MPa % or less.

(6) The optical stack structure according to the above (1), wherein the window includes an optical substrate formed of a polymer material.

(7) The optical stack structure according to the above (6), wherein the window further includes a hard coating layer on a surface or both surfaces of the optical substrate.

(8) The optical stack structure according to the above (6), wherein the window further includes a functional layer on a surface or both surfaces of the optical substrate.

(9) The optical stack structure according to the above (8), wherein the functional layer includes at least one of a UV blocking layer, an anti-scattering layer or an anti-fingerprint layer.

(10) The optical stack structure according to the above (1), further comprising a light-shielding pattern on a peripheral portion of the surface of the window.

(11) The optical stack structure according to the above (10), wherein the light-shielding pattern is disposed at the same level as that of the polarizing layer or the touch sensor layer.

(12) The optical stack structure according to the above (1), wherein an amended toughness of the window is 10,000 MPa % or more.

(13) The optical stack structure according to the above (1), wherein the window has a transmittance of 15% or less at a UV wavelength of 380 nm.

(14) The optical stack structure according to the above (1), wherein the window has a pencil hardness of 3H or more under a load of 1 kg.

(15) The optical stack structure according to the above (1), wherein Martens Hardness of the window is 200 N/mm² or more under a load of 10 mN.

(16) The optical stack structure according to the above (1), wherein the window satisfies Equation 2 below:

(Coefficient of friction/water contact angle)*1,000≤2.5/degree (°). [Equation 2]

(17) The optical stack structure according to the above (1), wherein the polarizing layer includes a stretched-type polarizer or a coating-type polarizer.

(18) The optical stack structure according to the above (17), wherein the polarizing layer further includes a protective film on at least one of one surface of the polarizer or an opposite surface facing the one surface of the polarizer.

(19) The optical stack structure according to the above (18), wherein the protective film includes a retardation film.

(20) The optical stack structure according to the above (19), wherein the protective film includes a first protective film and a second protective film formed on both surfaces of the polarizer, respectively, and the second protective film is the retardation film.

(21) The optical stack structure according to the above (17), wherein the coating-type polarizer includes a liquid crystal layer.

(22) The optical stack structure according to the above (21), wherein the liquid crystal layer contacts the window.

(23) The optical stack structure according to the above (21), wherein the coating-type polarizer further includes an alignment layer between the window and the liquid crystal layer.

(24) The optical stack structure according to the above (21), wherein the coating-type polarizer further includes an overcoat layer on the liquid crystal layer.

(25) The optical stack structure according to the above (1), wherein a polarizing degree of the polarizing layer is 95% or more.

(26) The optical stack structure according to the above (1), wherein a light transmittance of the polarizing layer is 42% or more.

(27) The optical stack structure according to the above (1), wherein a contractile force of the polarizing layer is 1.5 N or less.

(28) The optical stack structure according to the above (1), wherein the touch sensor layer includes an electrode.

(29) The optical stack structure according to the above (28), wherein the touch sensor layer further includes a substrate, and the electrode is formed on an upper surface of the substrate.

(30) The optical stack structure according to the above (28), wherein the electrode is directly formed on the window or the polarizing layer.

(31) The optical stack structure according to the above (28), wherein the electrode includes a first electrode and a second electrode which are arranged in directions crossing each other.

(32) The optical stack structure according to the above (31), wherein the first electrode is disposed on an upper surface of the polarizing layer and the second electrode is disposed on a lower surface of the polarizing layer.

(33) The optical stack structure according to the above (28), wherein the electrode has a sheet resistance of 500Ω/□ or less.

(34) The optical stack structure according to the above (28), wherein the electrode has a surface roughness of 1.5 nm or less.

(35) The optical stack structure according to the above (28), wherein a refractive index of the electrode is in a range from 1.3 to 2.5.

(36) The optical stack structure according to the above (1), wherein a light transmittance of the touch sensor layer is 85% or more.

(37) The optical stack structure according to the above (1), wherein the polarizing layer and the touch sensor layer are sequentially disposed from the surface of the window.

(38) The optical stack structure according to the above (1), wherein the touch sensor layer and the polarizing layer are sequentially disposed from the surface of the window.

(39) The optical stack structure according to the above (1), further comprising an adhesive layer formed in at least one region of between the window and the polarizing layer, between the window and the touch sensor layer, or between the polarizing layer and the touch sensor layer.

(40) An image display device comprising the optical stack structure according to any one of the above (1) to (39).

In the optical stack structure according to embodiments of the present invention, a window, a polarizing layer and a touch sensor layer may be integrated to be applied to an image display device. Thus, a mechanical property of each layer applied to a flexible display may be simultaneously controlled, and the optical stack structure having a desired flexibility while suppressing cracks, fractures, etc., may be realized with high reliability.

In exemplary embodiments, the optical stack structure may have an amended toughness of a specific value or more, which is defined as a multiplication of a stress and a strain at a fracture point. Thus, defects such as interlayer delamination, crack or tearing may be prevented while repeated bending or folding.

Further, the polarizing layer and the touch sensor layer may be integrated in the optical stack structure to be effectively applied to a thin-layered flexible display.

### BRIEF DESCRIPTION OF THE DRAWINGS

FIGS. 1, 2A and 2B are schematic cross-sectional view illustrating optical stack structures in accordance with exemplary embodiments;

FIGS. 3 to 7 are schematic cross-sectional views illustrating optical stack structures in accordance with some exemplary embodiments;

FIG. 8 is a schematic cross-sectional view illustrating an optical stack structure in accordance with some exemplary embodiments;

FIGS. 9 and 10 are schematic cross-sectional views illustrating structures of a touch sensor layer in accordance with some exemplary embodiments;

FIG. 11 is a schematic cross-sectional view illustrating an electrode arrangement of a touch sensor layer in accordance with some exemplary embodiments;

FIG. 12 is a schematic cross-sectional view illustrating an optical stack structure in accordance with exemplary embodiments;

FIGS. 13 and 14 are schematic cross-sectional views illustrating optical stack structures in accordance with exemplary embodiments;

FIGS. 15 to 17 are schematic cross-sectional views illustrating optical stack structures in accordance with some exemplary embodiments; and

FIG. 18 is a graph showing an amended toughness of an optical stack structure in accordance with exemplary embodiments.

### DETAILED DESCRIPTION

According to exemplary embodiments of the present invention, an optical stack structure including a window, and a polarizing layer and a touch sensor layer formed on a surface of the window is provided. The polarizing layer and the touch sensor layer may be integrated in the optical stack structure, and the optical stack structure may have an amended toughness equal to or greater than a specific threshold value and may also have improved flexibility and durability. According to exemplary embodiments of the present invention, an image display device including the optical stack structure is also provided.

Hereinafter, the present invention will be described in detail with reference to the accompanying drawings. However, those skilled in the art will appreciate that such embodiments described with reference to the accompanying drawings are provided to further understand the spirit of the present invention and do not limit subject matters to be protected as disclosed in the detailed description and appended claims.

Optical Stack Structure

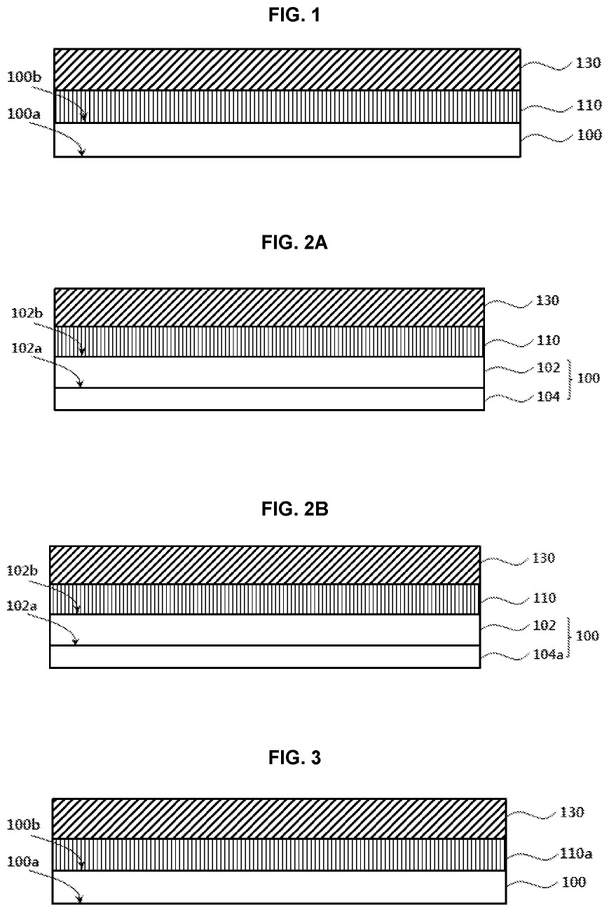

FIGS. 1, 2A and 2B are schematic cross-sectional view illustrating optical stack structures in accordance with exemplary embodiments. For example, the optical stack structure may be employed as a window stack structure of an image display device such as a flexible display.

Referring to FIG. 1, the optical stack structure may include a window 100, and a polarizing layer 110 and a touch sensor layer 130 disposed on a surface of the window 100.

The window 100 may serve as a window film or an optical substrate of the optical stack structure. The optical substrate may include a transparent material that may be viewed therethrough by a user and may have a durability to an external shock to be applied to an LCD device, an OLED device, a touch screen panel (TSP), etc. The optical substrate may also include a plastic material or a polymer material that may have a properly flexible property. In this case, a display device including the optical stack structure may be provided as a flexible display.

For example, the optical substrate may include polyimide (PI), polyethersulphone (PES), polyacrylate (PAR), polyetherimide (PEI), polyethylene naphthalate (PEN), polyethylene terephthalate (PET), polyphenylene sulfide (PPS), polyallylate, polycarbonate (PC), cellulose triacetate (TAC), cellulose acetate propionate (CAP), etc. These may be used alone or in a combination thereof.

The window 100 includes one surface 100b and an opposite surface 100a relative to the one surface 100b. For example, the one surface 100b and the opposite surface 100a may correspond to an upper surface and a lower surface, respectively.

The opposite surface 100a may be disposed toward a viewer side when the optical stack structure is applied to an image display device. For example, an image is displayed to a user through the opposite surface 100a of the window 100, and an instruction of the user may be input through the opposite surface 100a (e.g., by a touch of the user). The one surface 100b of the window 100 may face, e.g., a display panel, and additional layers and/or structures may be stacked or disposed on the one surface 100b.

As illustrated in FIG. 1, the polarizing layer 110 may be disposed on the one surface 100b of the window 100, and the touch sensor layer 130 may be disposed on the polarizing layer 110.

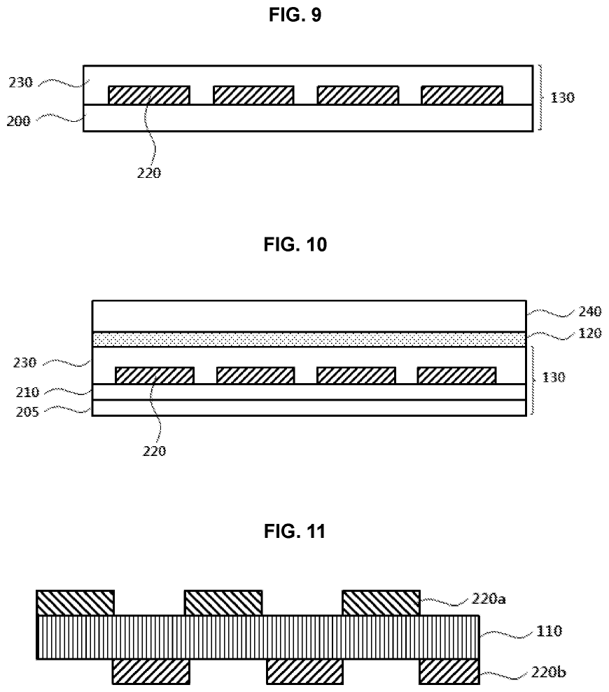

The polarizing layer 110 may include a coating-type polarizer or a stretched-type polarizer. The touch sensor layer 130 may be adhered to the polarizing layer 110. The touch sensor layer 130 may include electrode patterns for converting a touch signal input through the opposite surface 100a of the window 100 to an electrical signal. Detailed elements of the touch sensor layer 130 will be described with reference to FIGS. 9 and 10.

In exemplary embodiments, an adhesive layer may be formed between the polarizing layer 110 and the window 100, and/or between the touch sensor layer 130 and the polarizing layer 110.

The term used herein “adhesive layer” also includes a bonding layer and a tackifying layer. The adhesive layer may be formed using a pressure sensitive adhesive (PSA) composition or an optically clear adhesive (OCA) composition.

In some embodiments, as illustrated in FIG. 6, a first adhesive layer 120a may be formed between the polarizing layer 110 and the window 100. In an embodiment, the first adhesive layer 120a may be formed on the one surface 100b of the window 100, and then the polarizing layer 110 may be adhered to the window 100 through the first adhesive layer 120a. In an embodiment, the first adhesive layer 120a may be formed on the polarizing layer 110, and then may be attached to the window 100.

In some embodiments, as illustrated in FIG. 8, the touch sensor layer 130 may be combined with the polarizing layer 110 through a second adhesive layer 120b.

The adhesive layer may have a proper adhesion so that delamination, bubbles, etc., may not be caused when the optical stack structure is bent, and may also have a viscoelasticity to be applied to a flexible display. In some embodiments, the adhesive layer may be formed using an acrylate-based PSA composition in consideration of the aspects above. For example, the PSA composition may include a (meth)acrylic acid ester copolymer, a cross-linking agent and a solvent.

Types of the cross-linking agent may not be specifically limited, and the cross-linking agent commonly used in the related art may be properly used. For example, the cross-linking agent may include a polyisocyanate compound, an epoxy resin, a melamine resin, a urea resin, a dialdehyde compound, a methylol polymer, etc. Preferably, the polyisocyanate compound may be used.

The solvent widely used in a resin composition may be used. For example, an alcohol-based solvent (methanol, ethanol, isopropanol. butanol, propylene glycol methoxy alcohol, etc.), a ketone-based solvent (methyl ethyl ketone, methyl butyl ketone, methyl isobutyl ketone, diethyl ketone, dipropyl ketone, etc.), an acetate-based solvent (methyl acetate, ethyl acetate, butyl acetate, propylene glycol methoxy acetate, etc.), a cellosolve-based solvent (methyl cellosolve, ethyl cellosolve, propyl cellosolve, etc.), a hydrocarbon-based solvent (normal hexane, normal heptane, benzene, toluene, xylene, etc.), or the like. These may be used alone or in a combination thereof.

Referring to FIG. 2A, the window 100 may further include a hard coating layer 104. In exemplary embodiments, the window 100 may include a stack structure of an optical substrate 102 as described above and the hard coating layer 104.

For example, the optical substrate 102 may include one surface 102b and an opposite surface 102a, and the hard coating layer 104 may be formed on the opposite surface 102a of the optical substrate 102. In this case, a surface of the hard coating layer 104 may be exposed to a viewer side. The polarizing layer 110 and the touch sensor layer 130 may be stacked on the one surface 102b of the optical substrate 102.

The hard coating layer 104 may be formed using a hard coating composition that may include a photo-curable compound, a photo-initiator and a solvent so that flexibility, wear-resistance, surface hardness, etc., of the window 100 may be further improved.

The photo-curable compound may include, e.g., a siloxane-based compound, an acrylate-based compound, a compound having a (meth)acryloyl group or a vinyl group, etc. These may be used alone or in a combination thereof.

The siloxane-based compound may include, e.g., polydimethyl siloxane (PDMS). The siloxane-based compound may contain an epoxy group such as a glycidyl group. Accordingly, a cross-linking or curing reaction through an epoxy opening may be facilitated by a light irradiation.

The acrylate-based compound may include, e.g., dipentaerythritol hexa(meth)acrylate, dipentaerythritol penta(meth)acrylate, pentaerythritol tetra(meth)acrylate, ditrimethylol propane tetra(meth)acrylate, (meth)acrylate containing an oxyethylene group, ester (meth)acrylate, ether (meth)acrylate, epoxy (meth)acrylate, melamine (meth)acrylate, etc.

The compound having the (meth)acryloyl group or the vinyl group may include, e.g., (meth)acrylic acid ester, an N-vinyl compound, a vinyl-substituted aromatic compound, a vinyl ether compound, a vinyl ester compound, etc.

The photo-initiator may include a compound that may generate a Lewis acid or a radical by an active energy ray such as visible light, UV light, X-ray or electron beam to initiate a polymerization of the photo-curable compound. The photo-initiator may include, e.g., an onium salt such as aromatic diazonium salt, an aromatic iodonium salt, an aromatic sulfonium salt, etc., an acetophenone-based compound, a benzoin-based compound, a benzophenone-based compound, a thioxanthone-based compound, etc.

The solvent substantially the same as or similar to that used in the PSA composition may be also used, but not specifically limited thereto.

In some embodiments, the hard coating composition may further include a UV absorbing agent. A compound capable of absorbing a UV wavelength of 380 nm or less may be used as the UV absorbing agent without particular limitation. In some embodiments, the UV absorbing agent may include a benzoxazinone-based compound, a triazine-based compound, a benzotriazole-based compound or a benzophenone-based compound. These may be used alone or in a combination thereof. Accordingly, a UV transmittance may be reduced by the hard coating layer 104 so that an optical property and a transmittance of visible light may be enhanced.

As illustrated in FIGS. 1 and 2A, a single-layered structure of the optical substrate 102 may be employed as the window 100, or a multi-layered structure including the hard coating layer 104 and the optical substrate 102 may be employed as the window 100.

In some embodiments, the window 100 may include an additional hard coating layer formed on the one surface 102b of the optical substrate 102. In this case, the window 100 may include a stack structure of a first hard coating layer—a substrate film—a second hard coating layer.

Referring to FIG. 2B, the window 100 may further include at least one functional layer such as a UV blocking layer, an anti-scattering layer, an anti-fingerprint layer or the like which may be applied to an image display device. In some embodiments, a stack structure including the hard coating layer 104 illustrated in FIG. 2A and a functional layer 104a may be disposed on the opposite surface 102a of the optical substrate 102.

FIGS. 3 to 7 are schematic cross-sectional views illustrating optical stack structures in accordance with some exemplary embodiments.

Referring to FIG. 3, the polarizing layer may include a coating-type polarizer. For example, the polarizing layer may include a liquid crystal layer 110a.

In some embodiments, the liquid crystal layer 110a may be formed by coating a liquid crystal coating composition on the one surface 100b of the window 100. In this case, the liquid crystal layer 110a may directly contact the window 100. The liquid crystal coating composition may include a reactive liquid crystal compound and a dichroic dye.

The reactive liquid crystal compound may include a Reactive Mesogen (RM) providing a liquid crystal property, and a monomer molecule including a polymerizable functional end group and having a liquid crystal phase after a photo or thermal cross-linking reaction. When the reactive liquid crystal compound is polymerized by a light or heat irradiation, a polymer network may be created while maintaining a liquid crystal arrangement. A thin-layered polarizer having improved mechanical and thermal stability while maintaining optical anisotropic and dielectric properties of liquid crystals may be formed using the reactive liquid crystal compound.

The dichroic dye may be included in the liquid crystal coating composition to provide a polarizing property, and may have different absorbance at a long-axis direction of a molecule and a short-axis direction of the molecule. The dichroic dye may include an acridine dye, an oxazine dye, a cyanine dye, a naphthalene dye, an azo dye, an anthraquinone dye, etc. These may be used alone or in a combination thereof.

The liquid crystal coating composition may further include a solvent for dissolving the reactive liquid crystal compound and the dichroic dye. For example, propylene glycol monomethyl ether acetate (PGMEA), methyl ethyl ketone (MEK), xylene and chloroform may be used. The liquid crystal coating composition may further include a leveling agent, a polymerization initiator, etc., within a range not degrading the polarizing property of a coating layer.

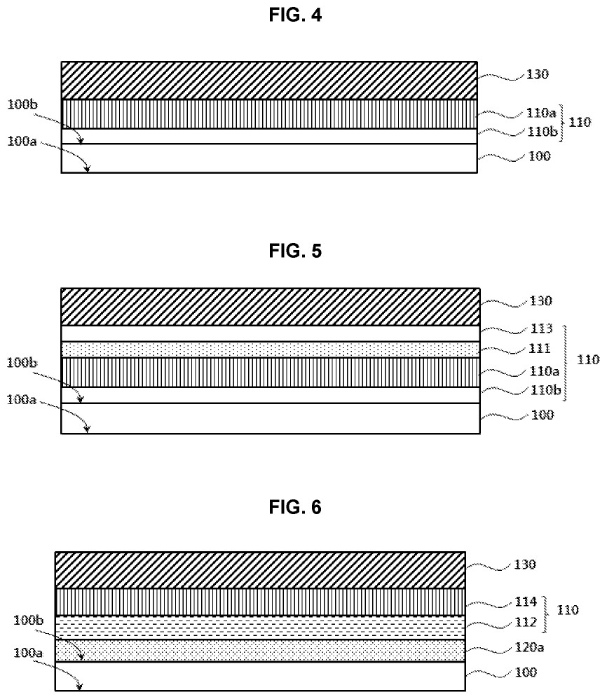

Referring to FIG. 4, the polarizing layer 110 may include the liquid crystal layer 110a and an alignment layer 110b. For example, the liquid crystal layer 110a may be formed on the alignment layer 110b.

For example, an alignment layer coating composition including an aligning polymer, a photo-polymerization initiator and a solvent may be coated and cured on the window 100 to form the alignment layer, and then the liquid crystal coating composition may be coated and cured on the alignment layer to form the polarizing layer 110 including the alignment layer 110b and the liquid crystal layer 110a.

The aligning polymer may include, e.g., a polyacrylate-based resin, a polyamic acid resin, a polyimide-based resin, a polymer containing a cinnamate group, etc.

Referring to FIG. 5, the polarizing layer 110 may further include an overcoat layer 111. For example, the overcoat layer 111 may be formed on an upper surface of the liquid crystal layer 110a to face the alignment layer 110b.

In some embodiments, as illustrated in FIG. 5, a protective film 113 may be disposed on the overcoat layer 111. In this case, the polarizing layer 110 may include a stack structure of the alignment layer—the liquid crystal layer—the overcoat layer—the protective film, and may have improved mechanical durability while maintaining transmittance.

The overcoat layer 111 may also substantially serve as an adhesive layer for combining the protective film 113. In an embodiment, an adhesive layer may be additionally formed between the overcoat layer 111 and the protective film 113.

In some embodiments, the protective film 113 may include an optical functional layer, e.g., a retardation film. The retardation film may serve as a functional layer by which a phase of a light through the liquid crystal layer 110a may be retarded. A material for the retardation film may not be specifically limited. For example, the retardation film may include an oblique stretching resin film, a liquid crystal coating layer, or the like.

For example, the retardation film may include a λ/4 film. The retardation film may have a multi-layered structure including the λ/4 film and a λ/2 film.

In some embodiments, the optical functional layer such as the retardation film may be further stacked on the protective film 113.

Referring to FIG. 6, the polarizing layer 110 may include a stretched-type polarizer 114. For example, the polarizing layer 110 may include a first protective film 112 and the stretched-type polarizer 114, and may substantially serve as a stretched-type polarizing plate.

The first protective film 112 may include a polyester-based resin such as polyethylene terephthalate, polyethylene isophthalate, polyethylene naphthalate, polybutylene terephthalate, etc.; a cellulose-based resin such as diacetyl cellulose, triacetyl cellulose, etc.; a polycarbonate-based resin; an acryl-based resin such as polymethyl(meth)acrylate, polyethyl(meth)acrylate, etc.; a cyclo olefin polymer (COP), or the like.

The stretched-type polarizer 114 may include, e.g., a stretched polyvinyl alcohol (PVA) resin. Preferably, the polyvinyl alcohol resin may be obtained by a saponification of a poly vinyl acetate-based resin. The poly vinyl acetate resin may include a homopolymer of vinyl acetate, or a copolymer of vinyl acetate and a monomer capable of being copolymerized with vinyl acetate. The monomer may include an unsaturated carboxylic acid-based monomer, an unsaturated sulfonic acid-based monomer, an olefin-based monomer, a vinyl ether-based monomer, an acrylamid-based monomer having an ammonium group, etc. The polyvinyl alcohol resin may be a modified resin, and may include, e.g., polyvinyl formal or polyvinyl acetal modified by aldehyde.

In exemplary embodiments, a first adhesive layer 120a may be formed on the first protective film 112 of the polarizing layer 110, and the polarizing layer 110 may be adhered to the window 100 via the first adhesive layer 120a.

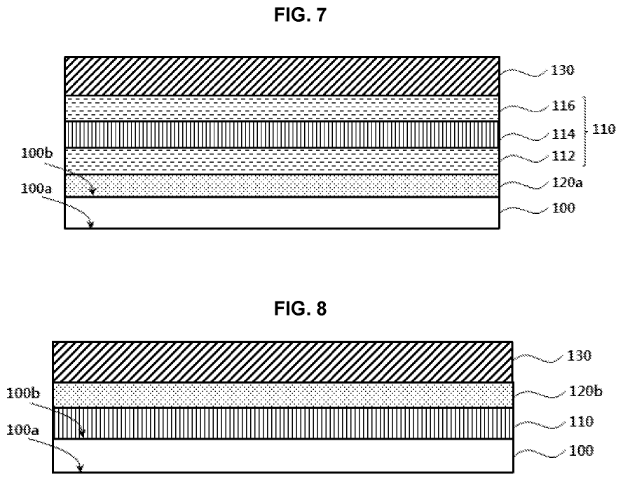

Referring to FIG. 7, the polarizing layer 110 may further include a second protective film 116 formed on an upper surface of the stretched-type polarizer 114. Accordingly, the polarizing layer 110 may serve as a polarizing plate including the first and second protective films 112 and 116, and the stretched-type polarizer 114 sandwiched therebetween.

In an embodiment, the second protective film 116 may include a material substantially the same as or similar to that of the first protective film 112.

In an embodiment, the second protective film 116 may include an optical functional layer. The optical functional layer may include, e.g., a retardation film as described above.

In some embodiments, the second protective film 116 may include a material substantially the same as or similar to that of the first protective film 112, and the optical functional layer such as the retardation film may be further formed on the second protective film 116.

FIG. 8 is a schematic cross-sectional view illustrating an optical stack structure in accordance with some exemplary embodiments. FIGS. 9 and 10 are schematic cross-sectional views illustrating structures of a touch sensor layer in accordance with some exemplary embodiments. FIG. 11 is a schematic cross-sectional view illustrating an electrode arrangement of a touch sensor layer in accordance with some exemplary embodiments.

Referring to FIG. 8, the touch sensor layer 130 may be adhered to the polarizing layer 110 via a second adhesive layer 120b. Referring to FIG. 9, the touch sensor layer 130 may include a substrate 200, and an electrode 220 disposed on the substrate 200. Further, an insulation layer 230 covering the electrodes 220 may be formed on the substrate 200.

The substrate 200 may include a flexible resin film such as a polyimide film. The electrodes 220 may include a sensing electrode configured to implement a touch sensing through a capacitance change, and a pad electrode for a signal transfer.

For example, the electrode 220 may include a metal, a metal wire (e.g., a metal nanowire) or a transparent conductive oxide.

The metal may include, e.g., silver (Ag), gold (Au), copper (Cu), aluminum (Al), platinum (Pt), palladium (Pd), chromium (Cr), titanium (Ti), tungsten (W), niobium (Nb), tantalum (Ta), vanadium (V), iron (Fe), manganese (Mn), cobalt (Co), nickel (Ni), zinc (Zn), or an alloy thereof. These may be used alone or in a combination thereof.

The transparent conductive oxide may include, e.g., indium tin oxide (ITO), indium zinc oxide (IZO), zinc oxide (ZnO), indium zinc tin oxide (IZTO), cadmium tin oxide (CTO), etc.

In an embodiment, the electrode 220 may include a stack structure such as a transparent metal oxide-metal wire, or a transparent metal oxide-metal (or metal wire)-transparent metal oxide.

In some embodiments, the touch sensor layer 130 may include a touch sensor operated in a mutual capacitance type. In this case, the sensing electrode may include first sensing electrodes and second sensing electrodes arranged to cross each other in different directions (e.g., X and Y directions).

For example, the first sensing electrodes may include unit patterns connected to each other to define a sensing line, and a plurality of the sensing lines may be arranged. The second sensing electrodes may include unit patterns physically isolated from each other. For example, a bridge electrode connecting the second sensing electrodes neighboring each other with respect to the first sensing electrode may be further included. In this case, the insulation layer 230 may include an insulation pattern that may serve as a supporting pattern of the bridge electrode while insulation the first and second sensing electrodes from each other.

In some embodiments, the touch sensor layer 130 may include a self-capacitance type touch sensor. In this case, the electrode 220 may include unit patterns physically isolated from each other. Each unit pattern may be electrically connected to a driving circuit via a trace or a wiring.

For example, the unit pattern may be formed by patterning a mesh metal electrode as a polygonal shape.

The insulation layer 230 may cover the electrodes 220 on the substrate 200. The insulation layer 230 may include an inorganic insulation material such as silicon oxide, or a transparent organic material such as an acryl-based resin.

In an embodiment, the substrate 200 of the touch sensor layer 130 may be adhered to the polarizing layer 110 through the second adhesive layer 120b. In an embodiment, the insulation layer 230 of the touch sensor layer 130 may be adhered to the polarizing layer 110.

Referring to FIG. 10, the touch sensor layer 130 may include a separation layer 205, an intermediate layer 210, the electrode 220 and the insulation layer 230.

The separation layer 205 may include a polymer organic layer. Non-limiting examples of a material for the separation layer 205 may include polyimide, polyvinyl alcohol, polyamic acid, polyamide, polyethylene, polystyrene, polynorbornene, phenylmaleimide copolymer, polyazobenzene, polyphenylene phthalamide, polyester, polymethyl methacrylate, polyarylate, a cinnamate-based polymer, a coumarin-based polymer, phthalimidine, a chalcone-based polymer, an aromatic acetylene-based polymer, or the like. These may be used alone or in a combination thereof.

In some embodiments, the separation layer 205 may be formed on a carrier substrate (not illustrated) such as a glass substrate, and may facilitate a detachment process from the carrier substrate after forming the electrode 220 and the insulation layer 230.

The intermediate layer 210 may be formed to protect the electrodes 220 of the touch sensor layer 130 and provide a refractive index matching with the electrodes 220. For example, the intermediate layer 210 may be formed of an inorganic insulation material such as silicon oxide, silicon nitride, silicon oxynitride, etc., or a polymeric organic insulation material.

In some embodiments, one of the separation layer 205 and the intermediate layer 210 may be omitted.

An adhesive layer 120 may be formed on the touch sensor layer 130, and a protective film 240 may be attached to the adhesive layer 120. For example, after attaching the protective film 240, the carrier substrate may be removed. Subsequently, the protective film 240 may be removed, and the touch sensor layer 130 may be stacked on the polarizing layer 110 using the adhesive layer 120.

In some embodiments, the adhesive layer 120 may be also removed together with the protective film 240, and an adhesive layer may be formed again on the insulation layer 230 to form an integrated optical stack structure.

In some embodiments, a substrate may be additionally combined toward the separation layer 205 after detaching the carrier substrate.

In some embodiments, the touch sensor layer 130 may be fabricated substantially as a substrate-less type. In this case, the electrodes 220 may be directly formed on the polarizing layer 110.

In some embodiments, the separation layer 205 and/or the intermediate layer 210 may serve substantially as a substrate, and may be integrated in the optical stack structure.

Referring to FIG. 11, electrodes included in the touch sensor layer may be dispersed in upper and lower surfaces of the polarizing layer 110.

In exemplary embodiments, first electrodes 220a may be arranged on the upper surface of the polarizing layer 110, and second electrodes 220b may be arranged on the lower surface of the polarizing layer 110.

For example, the first electrodes 220a may include sensing electrodes which may be arranged along a row direction (e.g., X-direction) to form a sensing line. The second electrodes 220b may include sensing electrodes which may be arranged along a column direction (e.g., Y-direction) to form a sensing line.

The first electrode 220a and the second electrode 220b may be disposed at different planes or different levels so that a bridge electrode for insulating the first and second electrodes 220a and 220b from each other may be omitted. Additionally, the polarizing layer 110 may serve substantially as a substrate of the touch sensor layer 130.

FIG. 12 is a schematic cross-sectional view illustrating an optical stack structure in accordance with exemplary embodiments. Referring to FIG. 12, the touch sensor layer 130 and the polarizing layer 110 may be sequentially stacked from one surface 100b of the window 100.

As described with reference to FIGS. 2A and 2B, the window 100 may include a stack structure of an optical substrate and a hard-coating layer, or an optical substrate and a functional layer.

According to an embodiment illustrated in FIG. 12, the touch sensor layer 130 may be positioned to be nearer to a viewer side or a touch input face. Thus, a sensitivity of a touch sensing or a signal transfer may be more enhanced.

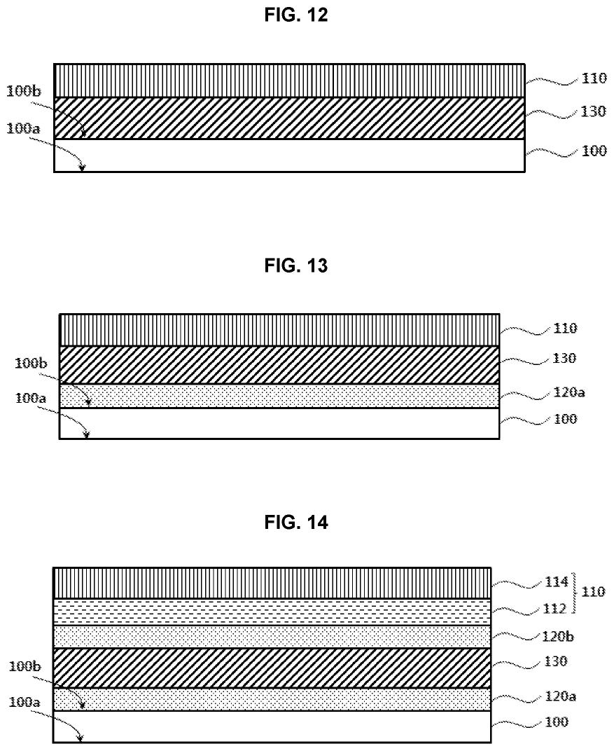

FIGS. 13 and 14 are schematic cross-sectional views illustrating optical stack structures in accordance with exemplary embodiments.

Referring to FIG. 13, in a window-touch sensor layer-polarizing layer structure illustrated in FIG. 12, the touch sensor layer 130 may be adhered to the window 100 through a first adhesive layer 120a.

As described with reference to FIG. 9, the touch sensor layer 130 may include a substrate and electrodes arranged on the substrate. In some embodiments, the touch sensor layer may be fabricated substantially as a substrate-less type. In this case, the electrodes may be directly formed on the window 100. In some embodiments, as illustrated in FIG. 10, the separation layer 205 and the intermediate layer 210 may serve substantially as a substrate.

In an embodiment, as illustrated in FIG. 11, the electrodes of the touch sensor layer 130 may be dispersed in upper and lower surfaces of the polarizing layer 110.

The polarizing layer 110 may include a coating-type polarizer as described with reference to FIG. 3, and may include an alignment layer and a liquid crystal layer as illustrated in FIG. 4. In some embodiments, as illustrated in FIG. 5, the polarizing layer 110 may include an overcoat layer formed on the liquid crystal layer.

Referring to FIG. 14, a second adhesive layer 120b may be included between the touch sensor layer 130 and the polarizing layer 110.

In some embodiments, the polarizing layer 110 may be a stretched-type polarizing plate including a first protective film 112 and a stretched-type polarizer 114.

In some embodiments, as illustrated in FIG. 7, the polarizing layer 110 may further include the second protective film 116 adhered on the stretched-type polarizer 114. For example, the second protective film 116 may include an optical functional layer such as a retardation film. The optical functional layer may be additionally stacked on the second protective film 116.

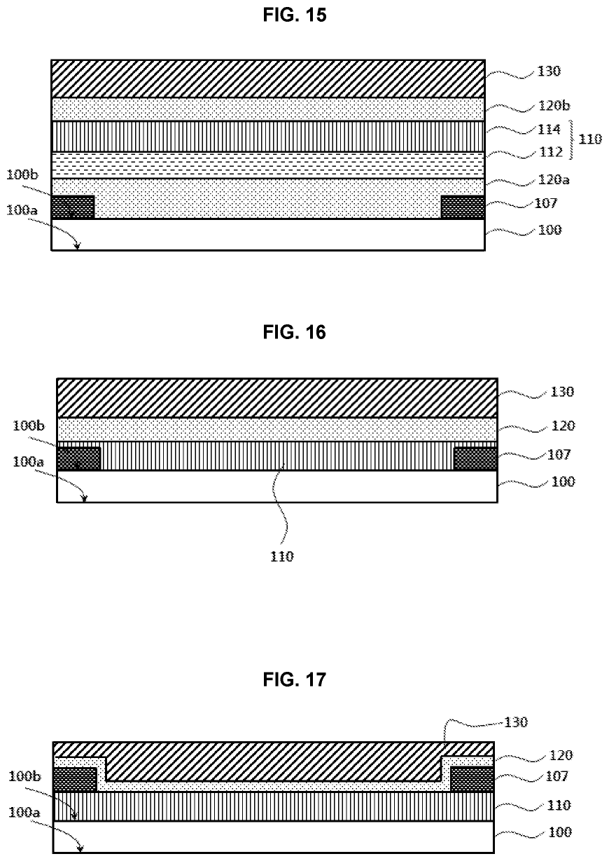

FIGS. 15 to 17 are schematic cross-sectional views illustrating optical stack structures in accordance with some exemplary embodiments. For example, FIGS. 15 to 17 illustrate examples of optical stack structures including a light-shielding pattern.

Referring to FIG. 15, a light-shielding pattern 107 may be formed on a peripheral portion of the one surface 100b of the window 100. For example, the light-shielding pattern 107 may serve as a bezel of the optical stack structure or an image display device.

The light-shielding pattern 107 may include a color pattern such as a white pattern or a black pattern, and may have a multi-layered structure of patterns having different colors. For example, the light-shielding pattern 107 may be formed of a resin material such as an acryl-based resin, an epoxy-based resin, polyurethane, silicone, or the like, mixed with pigment and/or dye for implementing colors.

The first adhesive layer 120a may be formed on a surface of the light-shielding pattern 107 and on the one surface 100b of the window 100. FIG. 15 illustrates that an upper surface of the first adhesive layer 120a is planar. However, the first adhesive layer 120a may be formed conformably along the surface of the light-shielding pattern 107 and on the one surface 100b of the window 100.

For example, the first protective film 112 of the polarizing layer 110 as described with reference to FIG. 6 may be adhered to the first adhesive layer 120a, and the touch sensor layer 130 may be stacked on the polarizing layer 110 via the second adhesive layer 120b.

Referring to FIG. 16, the light-shielding pattern 107 may laterally overlap the polarizing layer 110 or may be disposed at the same level as that of the polarizing layer 110. For example, the polarizing layer 110 may be a coating-type polarizer including a liquid crystal layer, and may be coated on the surface of the light-shielding pattern 107 and the one surface 100b of the window 100 as illustrated in FIG. 16.

In an embodiment, the polarizing layer 110 may be formed on a sidewall of the light-shielding pattern 107 and the one surface 100b of the window 100, and may not extend on a top surface of the light-shielding pattern 107.

Referring to FIG. 17, the light-shielding pattern 107 may laterally overlap the touch sensor layer 130 or may be disposed at the same level as that of the touch sensor layer 130.

For example, the light-shielding pattern 107 may be disposed on the polarizing layer 110, and the adhesive layer 120 may be formed on the light-shielding pattern 107 and the polarizing layer 110. The touch sensor layer 130 may be inserted in an opening that may be defined by the light-shielding pattern 107 through the adhesive layer 120. The polarizing layer 110 may have a structure including a coating-type polarizer as described with reference to FIGS. 3 to 5, or a structure including a stretched-type polarizer as described with reference to FIGS. 6 and 7.

A pad, a trace or a wiring included in the touch sensor layer 130 may vertically overlap the light-shielding pattern 107.

The optical stack structure according to embodiments of the present invention may have a construction in which a polarizer and a touch sensor are integrated with a window or an optical substrate. Thus, mechanical properties for obtaining flexibility, reliability and durability required when the optical structure is applied to a flexible display such as a flexible OLED device may be commonly controlled and adjusted in a stack structure unit.

Therefore, desired properties such as flexibility, hardness, delamination resistance, etc., may be effectively achieved compared when properties of an individual structure included in the flexible display are independently controlled.

In the optical structures according to exemplary embodiments as described with reference to FIGS. 1 to 17, an amended toughness of an entire optical stack structure may be controlled. In exemplary embodiments, the optical stack structure may satisfy Equation 1 below.

300 MPa %≤Amended Toughness [Equation 1]

In the Equation 1 above, “amended toughness” indicates a multiplication of a stress (MPa) and a strain (%) at a fracture point in a stress-strain curve of the optical stack structure.

The stress-strain curve is a graph showing a relation of a stress applied to a structure including polymer and a strain of the structure corresponding to the stress in a tensile test of the structure. The stress-strain curve represents a change of the stress required based on an increase of the strain of a polymeric material.

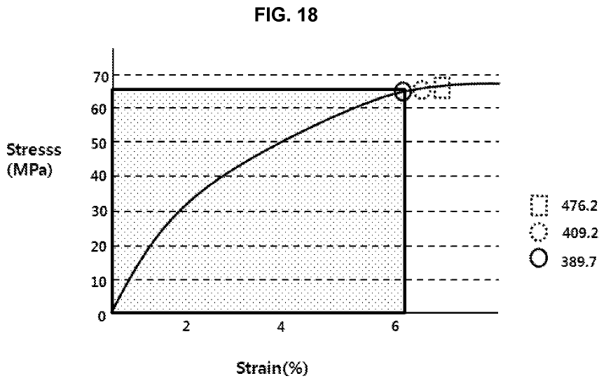

FIG. 18 is a graph showing an amended toughness of an optical stack structure in accordance with exemplary embodiments. Referring to FIG. 18, an X-axis represents a strain (%) and an Y-axis represents a stress (MPa). An area designated as a circle in FIG. 18 represents a fracture point at which the structure is fractured or torn as the strain increases. The amended toughness is a multiplication of an X-axis value (strain) and a Y-axis value (stress) at the fracture point, which corresponds to a section of a quadrangle designated by a thick line. FIG. 18 illustrates an example having the amended toughness of 389.7 MPa %.

In exemplary embodiments, the amended toughness of the optical stack structure may be adjusted to about 300 MPa % or more so that resistance to bending fatigue, cracks and delamination may be obtained together with high hardness. If the amended toughness of the optical stack structure is less than about 300 MPa %, a sufficient flexibility may not be obtained to cause interlayer delamination, cracks, etc., when the optical stack structure is applied to a flexible display. In some embodiments, the amended toughness of the optical stack structure may be about 400 MPa % or more. In this case, the flexibility of the optical stack structure may be more enhanced.

As the amended toughness becomes greater, the flexibility may be more improved. An upper limit of the amended toughness may not be specifically limited, but may be 1,000 MPa % or less from an economical aspect, preferably 800 MPa % or less.

According to exemplary embodiments, each layer or each structure of the optical stack structure may have optical, mechanical and electrical properties as described below.

The window 100 of the optical stack structure may inherently have an amended toughness of about 10,000 MPa % or more. For example, the term “window” used herein may indicate the optical substrate as described with reference to FIG. 1, or a stack structure of the optical substrate 102, the hard coating layer 104 and/or the functional layer 104a as described with reference to FIGS. 2A and 2B. As described above, the window may include a first hard coating layer and a second hard coating layer formed on one surface and an opposite surface, respectively, of the optical substrate.

In an embodiment, the window may have a pencil hardness of 3H or more under a load of 1 kg for protecting an outer surface of an image display device.

In an embodiment, a water contact angle of the window may be about 105 degree (°) or more. Within this range, anti-moisture, anti-fouling and anti-blocking properties of the window film may be improved.

In an embodiment, an impact force of the window may be about 70% or less relatively to that of a glass substrate having the same thickness. Thus, an anti-shock property of the optical stack structure may be improved, and a fracture by an external shock may be prevented.

In an embodiment, the window may have improved an anti-scratch property, and may also satisfy Equation 2 below.

(Coefficient of friction/water contact angle)*1,000≤2.5/degree (°) [Equation 2]

In an embodiment, the window may satisfy Equation 3 below.

Martens Hardness (HM)≥200 N/mm² [Equation 3]

In Equation 3, Martens Hardness is measured under a load of 10 mN.

In some embodiments, the window may satisfy both Equations 2 and 3 so that a surface hardness of the window may be improved while obtaining proper a slip property and thus the anti-scratch property may be enhanced.

In an embodiment, the window may have a transmittance of about 15% or less at a UV wavelength of 380 nm. The term “UV wavelength of 380 nm” used herein includes a precise 380 nm wavelength and also includes a wavelength of 380 nm to 390 nm. For example, the UV transmittance of the above range may be obtained using a UV absorbing agent included in the hard coating layer 104 or using a UV blocking layer in the functional layer 104a. Thus, a light resistance of the polarizing layer on the widow may be improved.

In an embodiment, a thickness of the window may be in a range from 40 to 150 μm.

The polarizing layer 110 included in the optical stack structure may include a coating-type polarizer or a stretched-type polarizer as described above.

In an embodiment, a polarizing degree (Py) of the polarizing layer may be about 95% or more, and a light transmittance of the polarizing layer may be 42% or more. If the polarizing layer is a stretched-type polarizing plate, a contractile force of the polarizing layer may be about 1.5 N or less. Thus, a high quality image may be implemented with desired polarizing property while obtaining a dimensional stability.

For example, the contractile force may be measured as an absolute value of contracting force when a sample having a size of 2 mm width×50 mm length (MD direction) is left at 80° C. for 2 hours. For example, the contractile force may be measured using an apparatus such as Q800 manufactured by TA-Instruments Corp.

In an embodiment, a thickness of the polarizing layer may be about 100 μm or less, for example in a range from about 5 to 100 μm.

A sheet resistance of the electrode 220 of the touch sensor layer 130 included in the optical stack structure may be about 500Ω/□ or less. A surface roughness of the electrode may be about 1.5 nm or less. Accordingly, improved sensing sensitivity and signal uniformity may be achieved.

In an embodiment, a light transmittance of the touch sensor layer may be about 85% or more, preferably about 89% or more. A refractive index of the touch sensor layer may be in a range from about 1.3 to about 2.5. Accordingly, the electrode 220 may be prevented from being viewed without degrading optical property or transmittance of the optical stack structure.

In an embodiment, a thickness of the touch sensor layer may be in a range from about 1 to 100 μm.

As described above, the optical stack structure may include at least one adhesive layer, and a thickness of each adhesive layer may be in a range from about 5 to 100 μm.

In exemplary embodiments, a total thickness of the optical stack structure may be adjusted to be 600 nm or less.

Image Display Device

According to embodiments of the present invention, an image display device including the optical stack structure as described above. The optical stack structure may be combined with a display panel included in an OLED device, an LCD device, etc. The display panel may include a pixel circuit including a thin film transistor (TFT) arranged on a substrate, and a pixel unit or a light emitting unit electrically connected to the pixel circuit.

For example, the optical stack structure as described with reference to FIGS. 1 to 17 may be disposed on the display panel. The optical stack structure may be provided as a window substrate or a window stack structure exposed to an outside of the image display device.

The image display device may be a flexible display. The image display device may be prevented from mechanical failures or damages such as cracks, delamination, fracture, etc., due to improved flexibility and durability when being folded or bent.

Hereinafter, preferred embodiments will be described to more concretely understand the present invention with reference to examples. However, it will be apparent to those skilled in the art that such embodiments are provided for illustrative purposes and various modifications and alterations may be possible without departing from the scope and spirit of the present invention, and such modifications and alterations are duly included in the present invention as defined by the appended claims.

### EXAMPLES AND COMPARATIVE EXAMPLES

### Example 1

(1) Preparation of Hard Coating Composition

35 parts by weight of hexafunctional acrylate (PU620D, Miwon Specialty Chemical) and 10 parts by weight of hexanediol diacrylate as a photo-curable resin, 2.7 parts by weight of 1-hydroxy-cyclohexyl-phenyl-ketone as a photo-initiator, 52 parts by weight of propylene glycol monomethyl ether as a solvent, and 0.3 parts by weight of BYK-UV3570 (BYK) as a leveling agent were mixed in a stirrer and filtered using a PP filter to prepare a hard coating composition.

(2) Fabrication of Window

The hard coating composition as prepared above was coated on an optical polyimide film having a thickness of 80 μm to have a thickness of 10 μm after curing, cured at 80° C. for 1 minute, and then cured using a high pressure mercury lamp with a light amount of 300 mJ/cm² to form a window including a hard coating layer.

(3) Fabrication of Window-Polarizing Plate Stack Structure

A first adhesive layer was formed on an opposite surface of the window with respect to a surface on which the hard coating layer was formed. A polyvinyl alcohol (PVA) polarizer having a thickness of 20 μm was attached on an 80 μm triacetyl cellulose (TAC) protective film, and then attached on the first adhesive layer such that the protective film and the polarizer were sequentially disposed on the first adhesive layer to obtain a window-polarizing plate stack structure.

### Example 2

35 parts by weight of hexafunctional acrylate (PU620D, Miwon Specialty Chemical) as a photo-curable resin, 10 parts by weight of 15 nm reactive silica sol dispersed in propylene glycol monomethyl ether (solid content 40%), 2.7 parts by weight of 1-hydroxy-cyclohexyl-phenyl-ketone as a photo-initiator, 52 parts by weight of propylene glycol monomethyl ether as a solvent, and 0.3 parts by weight of BYK-UV3570 (BYK) as a leveling agent were mixed in a stirrer and filtered using a PP filter to prepare a hard coating composition.

A window-polarizing plate stack structure was fabricated using the hard coating composition by processes the same as those of (2) and (3) of Example 1.

### Example 3

25 parts by weight of hexafunctional acrylate (PU620D, Miwon Specialty Chemical) as a photo-curable resin, 20 parts by weight of 15 nm reactive silica sol dispersed in propylene glycol monomethyl ether (solid content 40%), 2.7 parts by weight of 1-hydroxy-cyclohexyl-phenyl-ketone as a photo-initiator, 52 parts by weight of propylene glycol monomethyl ether as a solvent, and 0.3 parts by weight of BYK-UV3570 (BYK) as a leveling agent were mixed in a stirrer and filtered using a PP filter to prepare a hard coating composition.

A window-polarizing plate stack structure was fabricated using the hard coating composition by processes the same as those of (2) and (3) of Example 1.

### Example 4

A window-polarizing plate stack structure was fabricated by processes the same as those of Example 1 except that an 80 μm polymethyl methacrylate (PMMA) protective film was used.

### Example 5

A window-polarizing plate stack structure was fabricated by processes the same as those of Example 1 except that a 50 μm cyclo olefin polymer (COP) protective film was used.

### Comparative Example 1

A window-polarizing plate stack structure was fabricated by processes the same as those of Example 1 except that a thickness of the hard coating layer was 20 μm after curing in the process (2) of Example 1.

### Comparative Example 2

15 parts by weight of hexafunctional acrylate (PU620D, Miwon Specialty Chemical) as a photo-curable resin, 30 parts by weight of 15 nm reactive silica sol dispersed in propylene glycol monomethyl ether (solid content 40%), 2.7 parts by weight of 1-hydroxy-cyclohexyl-phenyl-ketone as a photo-initiator, 52 parts by weight of propylene glycol monomethyl ether as a solvent, and 0.3 parts by weight of BYK-UV3570 (BYK) as a leveling agent were mixed in a stirrer and filtered using a PP filter to prepare a hard coating composition.

A window-polarizing plate stack structure was fabricated using the hard coating composition by processes the same as those of (2) and (3) of Example 1.

### Comparative Example 3

15 parts by weight of pentaerythritol triacrylate as a photo-curable resin, 30 parts by weight of 15 nm reactive silica sol dispersed in propylene glycol monomethyl ether (solid content 40%), 2.7 parts by weight of 1-hydroxy-cyclohexyl-phenyl-ketone as a photo-initiator, 52 parts by weight of propylene glycol monomethyl ether as a solvent, and 0.3 parts by weight of BYK-UV3570 (BYK) as a leveling agent were mixed in a stirrer and filtered using a PP filter to prepare a hard coating composition.

A window-polarizing plate stack structure was fabricated using the hard coating composition by processes the same as those of (2) and (3) of Example 1.

### Experimental Example

An ITO pattern having a thickness of 45 nm as an electrode and a silicon oxide insulation layer were transferred on the polarizer of each window-polarizing plate stack structure fabricated in Examples 1 to 5, and Comparative Examples 1 to 3 to obtain an optical stack structure.

A sample having a size of 50 mm length×5 mm width was prepared from the optical stack structure, and an amended toughness of the sample was measured using AUTOGRAPH AG-X 1KN manufactured by SHIMAZHU Corp. Specifically, the sample was pulled at a constant speed of 4 mm/min along a length direction, and a stress according to a strain was measured until a fracture occurred. Accordingly, the stress and the strain were obtained at a fracture point. Then, the amended toughness according to Equation 1 was obtained from, e.g., a stress-strain curve as shown in FIG. 18.

A flexibility of each optical stack structure according to Examples and Comparative Examples was evaluated as follows, and the results are shown in Table 1.

Evaluation of Flexibility

A rod having a diameter of 3 mm was put on a center of a width of the optical stack structure (on the hard coating layer) according to Examples and Comparative Examples. The optical stack structure was folded until both sides of the optical stack structure in a length direction were in contact with each other, and restored to an original state. The above cycle was repeated, and the number of cycles was measured until a film fracture occurred. An evaluation standard is described below.

S: Fracture did not occur until 200,000 cycles

A: Fracture occurred in 100,000 cycles or more, and less than 200,000 cycles.

B: Fracture occurred in 50,000 cycles or more, and less than 100,000 cycles.

C: Fracture occurred in less than 50,000 cycles.

TABLE 11

| | Stress at fracture | Strain at fracture | Amended | Evaluation of |
|---|---|---|---|---|
| | point (Mpa) | point (%) | Toughness (MPa%) | Flexibility |
| Example 1 | 66.1 | 7.2 | 475.9 | S |
| Example 2 | 65.3 | 6.3 | 411.4 | S |
| Example 3 | 64.9 | 6.0 | 389.4 | A |
| Example 4 | 61.2 | 5.5 | 336.6 | A |
| Example 5 | 59.8 | 5.3 | 316.9 | A |
| Comparative | 56.4 | 5.2 | 293.3 | B |
| Example 1 | | | | |
| Comparative | 55.5 | 4.8 | 266.4 | C |
| Example 2 | | | | |
| Comparative | 53.8 | 4.5 | 242.1 | C |
| Example 3 | | | | |

Referring to Table 1, in the optical stack structures of Examples, when the amended toughness exceeded about 300 MPa %, improved flexibility was achieved substantially without causing fractures. The flexibility was further improved as the amended toughness exceeded about 400 MPa %.

In the optical stack structures of Comparative Examples, as the amended toughness was below about 300 MPa %, the fracture easily occurred. As the amended toughness decreased, the flexibility was further deteriorated.

What is claimed is:

1. An optical stack structure, comprising:
a window; and
a polarizing layer and a touch sensor layer on a surface of the window, wherein the optical stack structure satisfies Equation 1 below:
300 MPa %≤amended toughness [Equation 1]
wherein, in the Equation 1 above, the amended toughness is a multiplication of a stress (MPa) and a strain (%) at a fracture point in a stress-strain curve of the optical stack structure.

2. The optical stack structure according to claim 1, wherein the amended toughness is in a range from 400 MPa % to 1,000 MPa %.

3. The optical stack structure according to claim 1, wherein the window includes an optical substrate formed of a polymer material, and a hard coating layer formed on at least one surface of the optical substrate.

4. The optical stack structure according to claim 1, wherein the amended toughness of the window is 10,000 MPa % or more.

5. The optical stack structure according to claim 1, wherein the window has a transmittance of 15% or less at a UV wavelength of 380 nm.

6. The optical stack structure according to claim 1, wherein the window has a pencil hardness of 3H or more under a load of 1 kg.

7. The optical stack structure according to claim 1, wherein Martens Hardness of the window is 200 N/mm² or more under a load of 10 mN.

8. The optical stack structure according to claim 1, wherein the window satisfies Equation 2 below:
(Coefficient of friction/water contact angle)*1,000≤2.5/degree (°). [Equation 2]

9. The optical stack structure according to claim 1, wherein the polarizing layer includes a stretched-type or coating-type polarizer, and a protective film formed on at least one surface of the polarizer.

10. The optical stack structure according to claim 1, wherein a polarizing degree of the polarizing layer is 95% or more.

11. The optical stack structure according to claim 1, wherein a light transmittance of the polarizing layer is 42% or more.

12. The optical stack structure according to claim 1, wherein a contractile force of the polarizing layer is 1.5 N or less.

13. The optical stack structure according to claim 1, wherein the touch sensor layer includes an electrode, wherein the electrode is directly formed on the window or the polarizing layer.

14. The optical stack structure according to claim 13, wherein the electrode has a sheet resistance of 500Ω/□ or less.

15. The optical stack structure according to claim 13, wherein the electrode has a surface roughness of 1.5 nm or less.

16. The optical stack structure according to claim 13, wherein a refractive index of the electrode is in a range from 1.3 to 2.5.

17. The optical stack structure according to claim 1, wherein a light transmittance of the touch sensor layer is 85% or more.

18. The optical stack structure according to claim 1, wherein the polarizing layer and the touch sensor layer are sequentially disposed from the surface of the window.

19. The optical stack structure according to claim 1, wherein the touch sensor layer and the polarizing layer are sequentially disposed from the surface of the window.

20. An image display device comprising the optical stack structure according to claim 1.
